(19) United States
(12) Patent Application Publication
(10) Pub. No.: US 2018/0096032 A1
(43) Pub. Date: Apr. 5, 2018

(54) METADATA APPLICATION PROGRAMMING INTERFACE FOR AD HOC DATABASE QUERIES

(71) Applicant: SAP SE, Walldorf (DE)

(72) Inventors: Bjoern Mielenhausen, Plankstadt (DE); Manuel Caroli, Walldorf (DE); Youssef Hatem, Walldorf (DE)

(21) Appl. No.: 15/282,413

(22) Filed: Sep. 30, 2016

(51) Int. Cl. G06F 17/30

(52) U.S. Cl. CPC G06F 17/30466; G06F 17/30557

(57) ABSTRACT

Embodiments include a metadata application programming interface (API) for processing ad hoc database queries. Embodiments can be configured to process ad hoc database queries to determine the structure of the resulting data set and to provide metadata in the form of a result table, for example, in response to the queries that describes the structure of the data to be accessed by the queries. In one embodiment, this may be performed without accessing the data that would be retrieved upon executing the query. Certain embodiments may be adapted to prevent execution of the query and to return the metadata describing the structure of the data structure(s) in the resulting data set. A new “describe” statement can be incorporated into a query language expression and configured to work in a functionally coordinated manner with the API to implement a “describe” function in accordance with the techniques described in this disclosure.

### TECHNICAL FIELD

The embodiments described in this disclosure relate generally to database systems, and more particularly to accessing metadata describing data structures stored in a database.

### BACKGROUND

Conventional database systems, such as relational database systems, are adapted to provide access to data stored in one or more databases. Database systems include a database management system (“DBMS”) for interfacing with one or more client computing devices to manage access to the data stored in the databases managed by the DBMS. Databases also store metadata that describes the structure of the data stored in the database(s). The data may be stored in one or more data structures in the database(s) and these data structures may include database tables, views, arrays, objects, artifacts, etc. For example, metadata describing data structures stored in a database system may designate how many rows and columns are in a particular database structure (e.g., database table) as well as the data structure name, column names, data types, descriptions of the data stored in the data structure, and so on.

However in terms of metadata describing data structures stored in the database(s), conventional DBMSs are only configured to access and retrieve the metadata corresponding to static data structures in the database that are already predefined and listed in one or more catalogs of the DBMS. They are not configured to access metadata for dynamic queries, such as ad hoc queries, that are configured to retrieve more complex data structures when they are executed. Ad hoc queries are often constructed in the application layer and used to retrieve data on an as-needed basis as contrasted with a typical database query that is predefined and routinely processed. The result of executing ad hoc queries therefore cannot be determined prior to the moment the query issues. Further, an ad hoc query may involve one or more complex join conditions and a DBMS cannot determine in advance which columns will be returned in the resulting data set until the join condition(s) are evaluated. The structure of an ad hoc query may also depend on user input. For example, a user may want to hide certain columns in a database table or may want to add additional computed columns to the resulting data structure, etc.

As a consequence, ad hoc queries cannot be predefined in the catalogs of a DBMS. Conventional database systems only recognize the metadata that is stored in the catalogs of the DBMS for the static data structures (e.g., tables, views, etc.) stored in the database(s). So generating a view for all potential ad hoc queries in a particular system is prohibitively complex and will incur substantial overhead; and may also incur risk of returning nonsensical resulting data.

### SUMMARY

The embodiments described in this disclosure include improved systems and methods for providing a metadata application programming interface (“API”) for ad hoc queries. This disclosure describes a mechanism to determine the structure of a result set for an ad hoc database query. In one embodiment, this may be performed without accessing the data itself that is to be retrieved in response to executing the query.

Embodiments may further be configured to provide a new statement, referred to in this disclosure as a “describe” statement that can be incorporated into a query language expression. For example, the describe statement may be incorporated into a Structured Query Language (“SQL”) expression. The describe statement may be configured to work in a functionally coordinated manner with a new “describe function” API that can be integrated into a DBMS to manage accessing metadata in accordance with the techniques described in this disclosure. In this regard, at least certain embodiments described in this disclosure are adapted to prevent execution of the query in the describe statement and return only the metadata describing the result set that would be retrieved if the query were executed.

An embodiment of a method comprises: at a computer system in a network, the computer system comprising at least one processor and a memory in communication with the processor for storing computer code comprising instructions executable by the processor. A database query is received configured for implementing a describe function from a client computing device via the network, the database query comprising a describe statement coded in a query language configured to access the describe function. The database query is passed to an application programming interface (API) configured for implementing the describe function. The database query is processed at the API in accordance with the describe function. Processing the describe function in accordance with the describe function comprises: (1) analyzing the database query to determine what data stored in one or more databases in communication with the computer system would be accessed if the database query were executed, (2) searching the one or more databases to identify metadata describing the structure of the data to be accessed by the database query, and (3) retrieving the metadata from the one or more databases without accessing the data for the database query, wherein the metadata describes the structure of the data for the database query and includes metadata for one or more columns of the resulting data structure.

An embodiment of a system is in communication with one or more databases via one or more communication networks, the system comprising at least one processor and a memory configured to store programmed computer code executable by the processor to perform operations. The operations comprise receiving a database query configured for implementing a describe function from a client computing device via the network, the database query comprising a describe statement coded in a query language configured to access the describe function. The database query is passed to an application programming interface (API) configured for implementing the describe function. The database query is processed at the API in accordance with the describe function. Processing the describe function in accordance with the describe function comprises (1) analyzing the database query to determine what data stored in one or more databases in communication with the computer system would be accessed if the database query were executed, (2) searching the one or more databases to identify metadata describing the structure of the data to be accessed by the database query, and (3) retrieving the metadata from the one or more databases without accessing the data for the database query, wherein the metadata describes the structure of the data for the database query and includes metadata for one or more columns of the resulting data structure.

An embodiment of a non-transitory computer readable storage medium stores programmed computer code executable by a computer system comprising at least one processor and a memory in communication with the processor. The operations comprise receiving a database query configured for implementing a describe function from a client computing device via the network, the database query comprising a describe statement coded in a query language configured to access the describe function. The database query is passed to an application programming interface (API) configured for implementing the describe function. The database query is processed at the API in accordance with the describe function. Processing the describe function in accordance with the describe function comprises (1) analyzing the database query to determine what data stored in one or more databases in communication with the computer system would be accessed if the database query were executed, (2) searching the one or more databases to identify metadata describing the structure of the data to be accessed by the database query, (3) retrieving the metadata from the one or more databases without accessing the data for the database query, wherein the metadata describes the structure of the data for the database query and includes metadata for one or more columns of the resulting data structure.

Certain embodiments comprise communicating a resulting data structure comprising the metadata to the client computing device.

In some embodiments the describe function takes the computed data structure as an input operand and generates the resulting data structure with one row per column of the computed data structure.

Various embodiments further comprise preventing execution of the database query during processing of the describe statement, wherein the database query is not executed on the computed data structure to retrieve corresponding data from the one or more databases.

According to particular embodiments the describe function uses a query parser in order to analyze the database query and determine the structure of the computed data structure based on the metadata.

In certain embodiments the metadata for the computed data structure is retrieved as if it were metadata for a static data structure stored in the database having the computed data structure.

Some embodiments further comprise running a compiler on the describe statement to analyze the database query.

In various embodiments the query comprises an ad hoc query and includes at least one join condition.

According to particular embodiments the resulting data structure comprises a column name for the columns in the computed data structure, the data type for the columns in the computed data structure, and a description of the columns in the computed data structure.

The following detailed description and accompanying drawings provide a better understanding of the nature and advantages of the present disclosure.

### BRIEF DESCRIPTION OF THE DRAWINGS

For a better understanding of the embodiments described in this disclosure, reference is made to the following detailed description, which is to be read in conjunction with the accompanying drawings.

FIG. 1 depicts a conceptual overview block diagram of an example embodiment of a system comprising a metadata API for ad hoc database queries in accordance with at least certain techniques described in this disclosure.

FIG. 2 depicts a graphical representation of various join conditions that can be utilized for joining data in a data access operation.

FIG. 3 depicts a conceptual overview block diagram of an example embodiment of a server computer comprising a metadata API for ad hoc database queries in accordance with at least certain techniques described in this disclosure.

FIG. 4A depicts a flow chart of an example embodiment of a process for accessing metadata for ad hoc database queries in accordance with at least certain techniques described in this disclosure.

FIG. 4B depicts a flow chart of an example embodiment of a process for accessing metadata for ad hoc database queries in accordance with at least certain techniques described in this disclosure.

FIG. 5 depicts an example overview block diagram of a data processing system upon which the embodiments described in this disclosure may be implemented.

### DETAILED DESCRIPTION

Throughout the description, for the purposes of explanation, numerous specific details are set forth in order to provide a thorough understanding of the present disclosure. The embodiments described in this disclosure include improved systems, methods and computer readable media that provide for a metadata API configured for processing ad hoc queries. It will be apparent to one skilled in the art, however, that the techniques described in this disclosure may be practiced without some of these specific details. In other instances, well-known structures and devices may be shown in block diagram form to avoid obscuring the underlying principles of the techniques described in this disclosure.

The disclosed embodiments include improved methods, systems, and computer readable media adapted to provide a metadata API for ad hoc queries. The disclosed techniques can be advantageous for providing, among other things, insight into the structure of data stored in a database before having to perform operations on the data. This disclosure describes a mechanism to determine the structure of a result set for an ad hoc database query. In one embodiment, this may be performed without accessing the data itself that is to be retrieved upon executing the query.

Embodiments may be configured to provide a new database query language statement, referred to herein as a “describe” statement that can be incorporated into a query language expression. The describe statement may be configured to work in a functionally coordinated manner with a new “describe function” API that can be incorporated into a DBMS to manage accessing the structural metadata information in accordance with the techniques described in this disclosure. In this regard, at least certain embodiments described in this disclosure are adapted to prevent execution of the query in the describe statement and to return only the metadata describing the structure of the data structure(s) in the data set that would result from execution of the query.

In one embodiment, the ad hoc queries can be processed to determine the structure of the data set resulting from execution of the query without accessing the data itself. More particularly, the techniques described in this disclosure may be configured to receive and process ad hoc queries, or other such dynamic queries, containing the disclosed “describe” statement that may work in a functionally coordinated manner with the metadata API in a database system to retrieve metadata information about the structure of the data to be accessed (e.g., database table, view, etc.). In one embodiment, this can be performed without having to incur the bandwidth and latency requirements for accessing the entire data set itself. The disclosed embodiments can then be adapted to provide the requesting user client computing device with a result table (or other resulting data structure) that contains metadata information describing the structure of the data to be accessed by the ad hoc query.

It should be noted at the outset that, although the embodiments are described in terms of ad hoc queries, the techniques described in this disclosure are not so limited. Embodiments can be implemented with any type or mode of querying a database where the structure of the data to be accessed is dynamic and is incapable of being predetermined or known until after the database query issues.

In many cases, the data accessed upon execution of the ad hoc query may be computed based on evaluating one or more conditions specified in the query, such as one or more join conditions, for example. Once the structure of the data structure accessed by the query is determined and/or computed, the metadata describing that structure can be returned to a requesting client device in a result table (or other data structure). In one embodiment, this process can be performed without ever accessing the resulting data set itself. In such cases, the structure of the resulting data set may comprise a certain data structure(s) type, and the embodiments described in this disclosure can be adapted to provide metadata describing the resulting data structure to provide such information to users before the actual data itself need be accessed.

In one embodiment, the result data structure (e.g., result table) comprising the metadata describing the resulting data set can be determined based on (1) analyzing the database query to determine what data stored in one or more databases would be accessed if the database query were executed, (2) searching the one or more databases to identify metadata describing the structure of the data to be accessed by the database query, and (3) retrieving the metadata from the one or more databases that describes the data structure of the data to be accessed upon execution of the query without accessing the data itself. The result data structure of metadata describing the resulting data set can then be communicated back to the requesting client computing device in a result table (or other data structure). In one embodiment, the metadata in the result table may include the column name, column data type, and column description of the data structure to be accessed upon execution of the query (e.g., database table, object, or other artifact).

These techniques can be advantageous for a number of reasons as described in more detail below.

I. Illustrative Systems

Provided below is a description of example systems upon which the embodiments described in this disclosure may be implemented. Although certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner.

In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks.

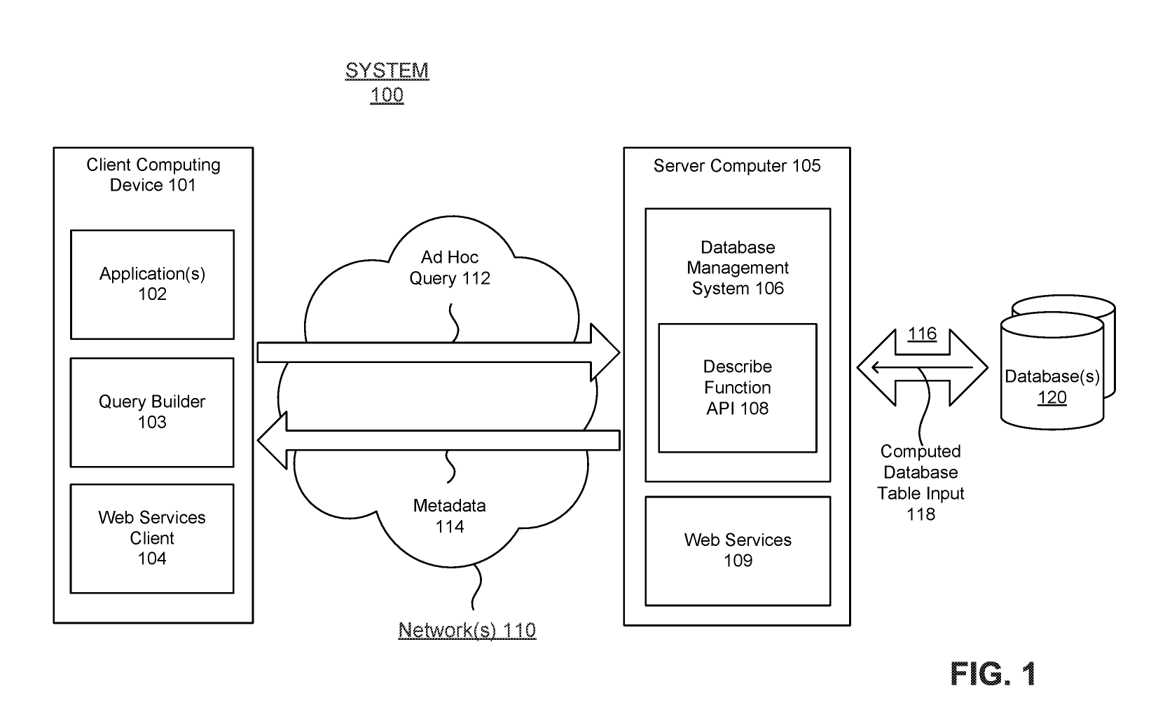

FIG. 1 depicts a conceptual overview block diagram of an example embodiment of a system comprising a metadata API for processing ad hoc database queries in accordance with at least certain techniques described in this disclosure. In the illustrated embodiment, system 100 includes a client computing device 101 in communication with a server computer 105 over one or more networks 110. The client computing device 101 includes one or more applications 102, a database query builder 103, and web services client 104. The server computer 105 includes a database management system (“DBMS”) 106 comprising a describe function API 108, and web services 109. The client computing device 101 can be configured to communicate with the server 105 over the one or more networks 110 via the web services client 104 at the client 101 and the web services 109 at the server 105.

In the depicted embodiment the client computing device 101 communicates ad hoc queries 112 to the server computer 105 and the server 105 responds by providing metadata 114 to the client computing device. In one embodiment the metadata 114 describes the structure of the data structures to be accessed by executing the ad hoc queries 112. The metadata may be communicated back to the client computing device 101 in a result table or other data structure. As discussed above, the result table may contain the metadata information relating to the structure of the data to be retrieved when the query is actually executed, which may be communicated to the client computing device 101 in a result table or other data structure. The metadata 114 provided to the client device 101 may include the column names, data types, and column descriptions for any data structure(s) (e.g., database table, view, object, or other artifact) to be accessed by executing the ad hoc query.

The following is an example of pseudo code for creating tables for a database, and utilizing a describe statement on an ad hoc query for accessing these data structures. The Orders and Customers database tables are created with the following pseudo code:

```
CREATE TABLE Orders (
    OrderID INT,
    OrderDate DATE,
    ...
    CustomerID INT - FK to Table Customers
);
CREATE TABLE Customers (
    CustomerID INT,
    Name TEXT
);
```

Now consider an ad hoc query for accessing the “Orders” and “Customers” database tables using a JOIN condition as follows:

SELECT OrderDate, Name AS CustName FROM Orders LEFT JOIN Customers WHERE . . . .

In order to retrieve the meta-data information for the result set of the query, the programmer can simply issue a query using the describe function as follows:
DESCRIBE(SELECT OrderDate, Name AS CustName FROM Orders LEFT JOIN Customers WHERE . . . )

An example result table is shown below in TABLE 1 below.

TABLE 1

| Column name | Data type | Description |
|---|---|---|
| TABLE_SCHEMA | nvarchar(128) | Name of schema that contains |
| | | the table. |
| TABLE_NAME | nvarchar(128) | Table name. |
| COLUMN_NAME | nvarchar(128) | Column name. |
| ORDINAL_POSITION | Int | Column identification number. |
| COLUMN_DEFAULT | nvarchar(4000) | Default value of the column. |
| IS_NULLABLE | varchar(3) | Nullability of the column. If |
| | | this column allows for NULL, this |
| | | column returns YES. |
| | | Otherwise, NO is returned. |
| DATA_TYPE | nvarchar(128) | System-supplied data type. |
| CHARACTER_MAXIMUM_LENGTH | Int | Maximum length, in |
| | | characters, for binary data, |
| | | character data, or text and |
| | | image data. |
| | | −1 for xml and large-value type |
| | | data. Otherwise, NULL is |
| | | returned. |
| CHARACTER_OCTET_LENGTH | Int | Maximum length, in bytes, for |
| | | binary data, character data, or |
| | | text and image data. |
| | | −1 for xml and large-value type |
| | | data. Otherwise, NULL is |
| | | returned. |
| NUMERIC_PRECISION | Tinyint | Precision of approximate |
| | | numeric data, exact numeric data, |
| | | integer data, or monetary data. |
| | | Otherwise, NULL is returned. |
| NUMERIC_PRECISION_RADIX | Smallint | Precision radix of approximate |
| | | numeric data, exact numeric |
| | | data, integer data, or monetary |
| | | data. |
| | | Otherwise, NULL is returned. |
| NUMERIC_SCALE | Int | Scale of approximate numeric |
| | | data, exact numeric data, integer |
| | | data, or monetary data. Otherwise, |
| | | NULL is returned. |
| DATETIME_PRECISION | Smallint | Subtype code for datetime and |
| | | ISO interval data types. For |
| | | other data types, NULL is returned. |
| CHARACTER_SET_CATALOG | nvarchar(128) | Returns master. This indicates |
| | | the database in which the |
| | | character set is located, |
| | | if the column is character |
| | | data or text data type. |
| | | Otherwise, NULL is returned. |
| CHARACTER_SET_SCHEMA | nvarchar(128) | Always returns NULL. |
| CHARACTER_SET_NAME | nvarchar(128) | Returns the unique name for |
| | | the character set if this column |
| | | is character data or text data |
| | | type. Otherwise, NULL is returned. |
| COLLATION_CATALOG | nvarchar(128) | Always returns NULL. |
| COLLATION_SCHEMA | nvarchar(128) | Always returns NULL. |
| COLLATION_NAME | nvarchar(128) | Returns the unique name for |
| | | the collation if the column is |
| | | character data or text data type. |
| | | Otherwise, NULL is returned. |

As can be seen in TABLE 1, the metadata 114 in the result table may include information about the column names, data types, and descriptions of the structure of the data that will be returned when the query is subsequently executed.

As shown in FIG. 1, in system 100 the DBMS 106 of server 105 includes a describe function API 108. The DBMS 106 is configured to receive the database query 112 and to process the describe statement via the describe function API 108 to implement the describe function in accordance with the techniques described in this disclosure. Applications 102 stored on the client computing device 101 may be coded in various programming languages, such as JavaScript and PHP, for example. Executing these programs may generate a variety of database queries that are designed to obtain the information needed for program execution. In other cases, users of the client computing device 101 may manually construct their own database queries 112. Such database queries 112 may in some cases be complex, e.g., ad hoc database queries, and may include conditions that need to be evaluated before a resulting data set can be determined. Database queries, such as an ad hoc query 112, may include complex conditions that may need to be evaluated prior to accessing the resulting data set in order to determine the data structures accessed by the query.

In addition, the techniques described in this disclosure can be implemented to provide a describe function API 108 for the DBMS 106 that can be configured to process database queries 112 containing a describe statement and to return a result table (or other data structure) comprising metadata 114 that describes the structure of the various resulting data structure(s) that would be computed upon execution of the query. At least certain embodiments described in this disclosure may be adapted to receive the ad hoc queries 112 and the data set 118 (e.g., database table) resulting from executing such queries as inputs to the describe function API 108, and to provide the appropriate metadata 114 for the data structures to be accessed by the ad hoc query 112 as an output to the client computing device via network(s) 110. In at least certain embodiments, this can be done without accessing the data from the database(s) that would have been accessed if the database query 112 were fully executed in the server computer 105. In addition, users can specify the fields to be returned with the result metadata table 114 such as table name, column names, etc.

Referring to FIG. 1, the database queries 114 may be received by the DBMS 106 of the server 105. The describe function can be implemented using the describe function API 108 to perform the techniques described in this disclosure. More particularly, the DBMS 106 of the server 105 may be configured to receive the database queries 112 from the client device 101 and to process at least certain of the database queries 112 in accordance with the function(s) of the describe function API 108. In some cases, the describe function API 108 in the DBMS 106 may be implemented to process only dynamic queries, such as the ad hoc queries that include the new describe statement.

In at least certain embodiments, the query 112 is received and identified as a query containing a describe statement. Upon identification of at least one describe statement in the query 112 that relates to a describe function implemented by the describe function API 108 described in this disclosure, the describe function can process the describe statement and return the metadata data structure 114 corresponding to the query 112. In one embodiment, the query 112 and the computed database table 118 that would have been accessed upon execution of the query 112 can be passed as inputs to the describe function API 108 in the DBMS 106 via networks 110 and 116. The describe function API 108 can then access one or more databases 120 via one or more communication networks or links 116 in order to retrieve the metadata 114 without accessing the data itself. The metadata 114 can then be communicated to the client computing device 101 over one or more communication networks 110.

As will be appreciated by persons of skill in the art, the various networks or communication links 110 and 116 described in this disclosure may be implemented as any single wired or wireless network, or as multiple separate networks 110 and 116 in communication with one another. The networks or communication links 110 and 116 may be implemented as any wired or wireless network(s). For example, the networks or communication links 110 and 116 can be implemented as a local area network (“LAN”), wide-area network (“WAN”), combination of LANs and WANs, the Internet, or any other type of communication network adapted for communicating electronic messages and information. Further, the networks 110 and 116 described in this disclosure may be implemented as a physical array of hardware resources or as a virtual array, or any combination thereof. The networks may also be implemented in a cloud-based network configuration. For example, the networks described in this disclosure may be implemented as public or private cloud network, or combination thereof. No specific network or network architecture should be construed as limiting the embodiments and techniques described herein.

In one example case, the database(s) 120 presented in FIG. 1 may comprise an in-memory database available from SAP SE of Walldorf, Germany, implemented as a HANA database. However, embodiments are not limited to use with this particular database. Examples of other in-memory databases include, but are not limited to, the SYBASE IQ database also available from SAP SE; the Microsoft Embedded SQL for C (ESQL/5 C) database available from Microsoft Corp. of Redmond, Wash.; the Exalytics In-Memory database available from Oracle Corp. of Redwood Shores, Calif., etc. Further, while embodiments described in this disclosure relate to an in-memory database, various embodiments can be employed using a conventional disk-based database system.

In one embodiment, the describe function may be a table valued function that allows reflecting the structure of the resulting data set for any ad-hoc query. Since a table valued function is a predefined function, the query language such as SQL does not need to be extended. The describe function can take a table as an input operand, operate on any tables, and produce a result table with a row per column of the input table.

In one embodiment, the mechanism described in this disclosure can be configured to accomplish a number of advantages. For example, a user may want to print out a report on a display screen in a hypertext markup language (“HTML”). For printing the header line information for such a report, the describe function can be used to access the header line information for the resulting data set without having to manually look through the database to determine what column corresponds to the header line; and what data type the column is, etc. In addition, without the describe function mechanism described in this disclosure, the header information would need to be hardwired into the print statement by the user. But problems can occur when the database schema is changed, for example by adding or removing a column, and the print statement is not automatically updated. In such a case, the manual search for the header line information in the database would need to be repeated by the user.

Other advantages include providing users with information about a resulting data structure that can be used for processing the data in the correct formatting. The embodiments described in this disclosure may be implemented to learn the structural metadata in advance before making decisions on what format the data should be returned in. For example, if it is known in advance that a resulting column in the resulting data set includes a data type of type “date”, then the techniques described in this disclosure can be implemented to determine what format to print the column in, such as for example American or German date format, etc. Or if a resulting column includes a data type “amount”, a user may want to determine the format for the “amount” data in the appropriate column in advance before accessing the data. Otherwise, if an incorrect format for the amount data is used, some of the data in the result table 114 may be incomprehensible.

In one embodiment, the describe function may be purely data manipulation language (“DML”) with no additional data definition language (“DDL”) (e.g., that defines organization of data and associated metadata in a database) required for generating and maintaining views. Also the process of database credential management may be simplified since users only require privileges for select statement operations on database tables. No rights for executing DDL are required. This can add to the security of the database since DDL can sometimes jeopardize a system.

In addition, as discussed above, as discussed above the ad hoc query 112 may be a complex query and include at least one join condition that must be evaluated prior to determining the structure of the data to be accessed upon execution of the query. The resulting data set may only be determined upon evaluation of one or more conditions in the query 112. In such cases, it may be preferable for users to receive the structural metadata 114 information for the resulting data set before accessing the information itself.

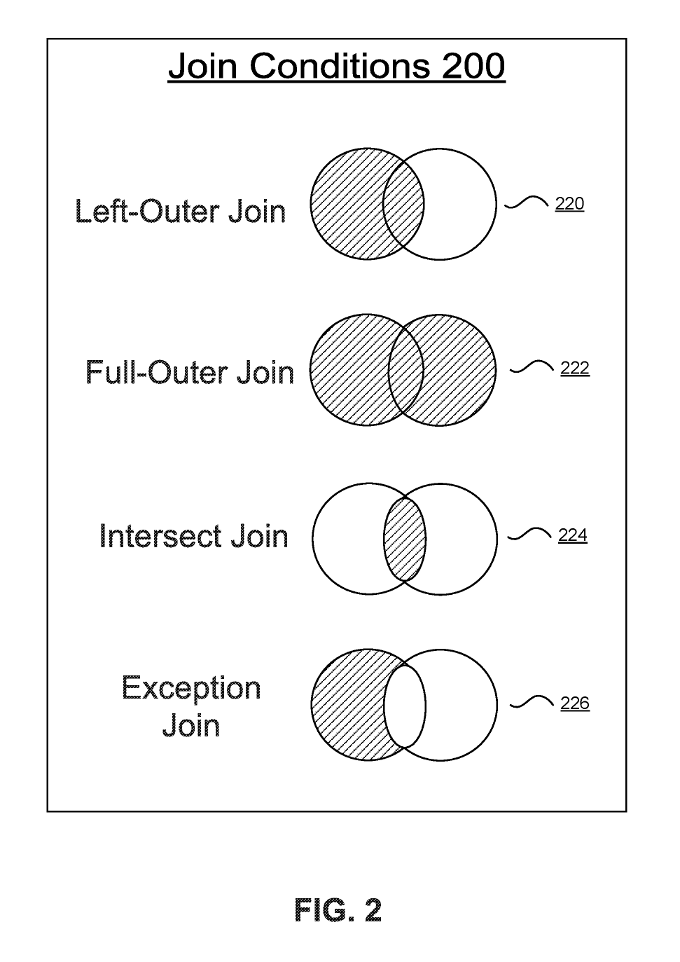

FIG. 2 depicts a graphical representation of various join conditions that can be utilized for joining data in a data access operation in accordance with at least certain embodiments described in this disclosure. The query 112 may include one or more join conditions that need to be processed for any specified join type including left-outer join 220, full-outer join 222, intersect join 224, or exception join 226. A left-outer join 220 can be adapted to return objects from the primary data set (i.e., left-hand side of a join operation) and match them up with objects from the one or more secondary data sets (i.e., right-hand side), and then to add null values for objects that do not match. A full-outer join 222 can be adapted to return the union of the objects in the columns of the primary data set with the objects in the columns of the one or more secondary data sets. An intersect join 224 can be adapted to only return objects that are common between data sets in an operation. And an exception join 226 can be adapted to only return objects that do not exist in the secondary data set(s).

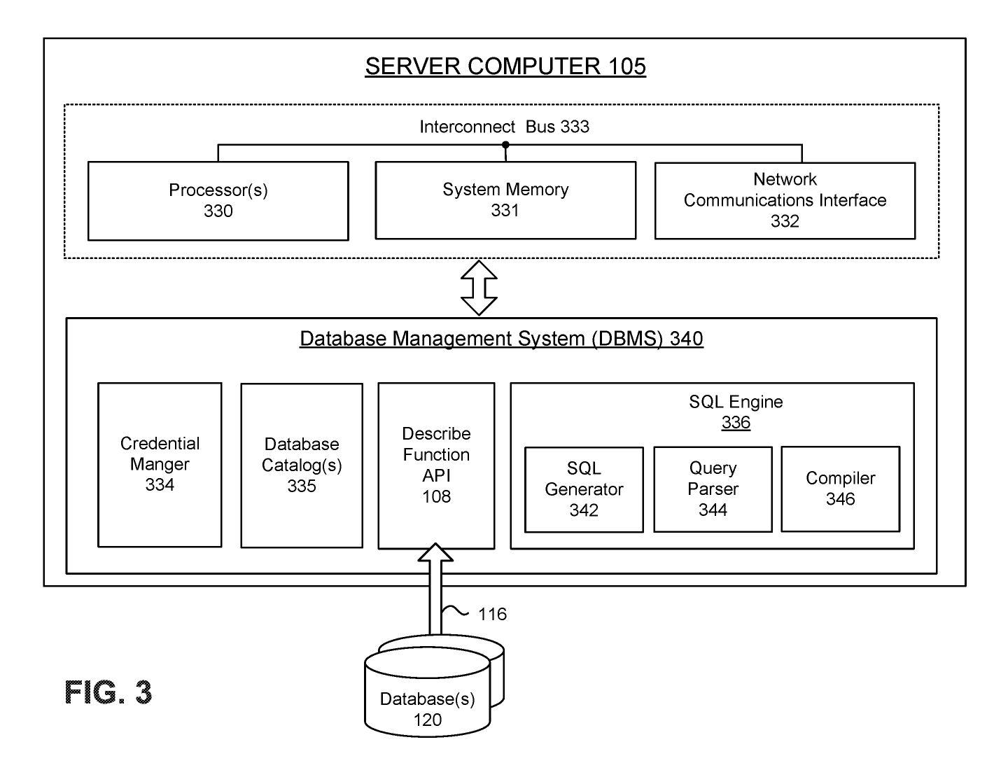

FIG. 3 depicts a conceptual overview block diagram of an example embodiment of a server computer 105 comprising a metadata API for ad hoc database queries in accordance with at least certain techniques described in this disclosure. In the illustrated embodiment, server computer 105 includes one or more processors 330, system memory 331, and a network communications interface 332, each in communication over one or more interconnect busses 333 (or other equivalent networks or communication links). In various embodiments, the server 105 can be configured to perform data accesses operations on data stored in the various databases 120 described in this disclosure via one or more communications networks or links 116. The server 105 may be implemented as an individual computer hardware server or as an array of computer hardware servers logically coupled together and working in a functionally coordinated manner. Generally, the computer hardware server described in this disclosure comprises a system configured to perform data access operations with respect to data stored in one or more repositories of data (e.g., database(s)) 120. Depending on the type of server, data operations may range from simple operations, such as storing and retrieving data, to more complex operations such as calculating statistics based on the data; or arranging, modifying, or formatting data.

In addition, the server 105 may be in remote communication with the databases 120 via one or more communication links or networks 116. Alternatively, database(s) 120 may be components of the server 105 and configured to communicate with the server 105 via any direct or indirect connection or network 116. In addition, the database(s) 120 may be implemented as any type of database system. One example embodiment includes a relational database system in which data is stored in structured database tables (or other data structures) comprised of rows and columns, and accessed through data storage rules (or schemas). Other examples of database systems include database systems where data can be stored in a semi-structured or unstructured format.

In the depicted embodiment of FIG. 3, server 105 includes a database management system (DBMS) 340 comprising a credential manager 334, one or more database catalogs 335, a describe function API 108, and a SQL engine 336. The SQL engine 336 further comprises a SQL generator 342, a query parser, 344, and a compiler 346. In one embodiment, the compiler 346 is configured to compile the database queries received from client computing devices. The query parser 344 may then parse database queries and may identify one or more describe statements contained in the queries. The identified described statements can be processed by the describe function API 108 in accordance with the describe function described in this disclosure.

The SQL engine 336 may include various calculation logic designed to conduct operations on the data stored in the database. Such logic may be performed to provide basic data definition and processing based on the schema of the database system. Such data definition can include defining data types, identifying associated metadata, and determining the database structure (e.g., columns, tables, views, etc.) The SQL generator 342 can be configured to generate query language expressions for accessing the metadata stored in the database(s) 120. The query language may be used to conveniently and efficiently read data from the database(s) 120 based on one or more data models.

A metadata result table containing the structure information for the resulting data set can then be retrieved from the one or more databases 120 without accessing the data itself in accordance with the described techniques. At least certain embodiments are configured to prevent processing of queries for a describe statement. The metadata result table can then be communicated to the client device.

The DBMS 340 further includes a credential manager 334. The credential manager 334 may be operable to manage credentials for authorization and authentication purposes.

II. Illustrative Processes

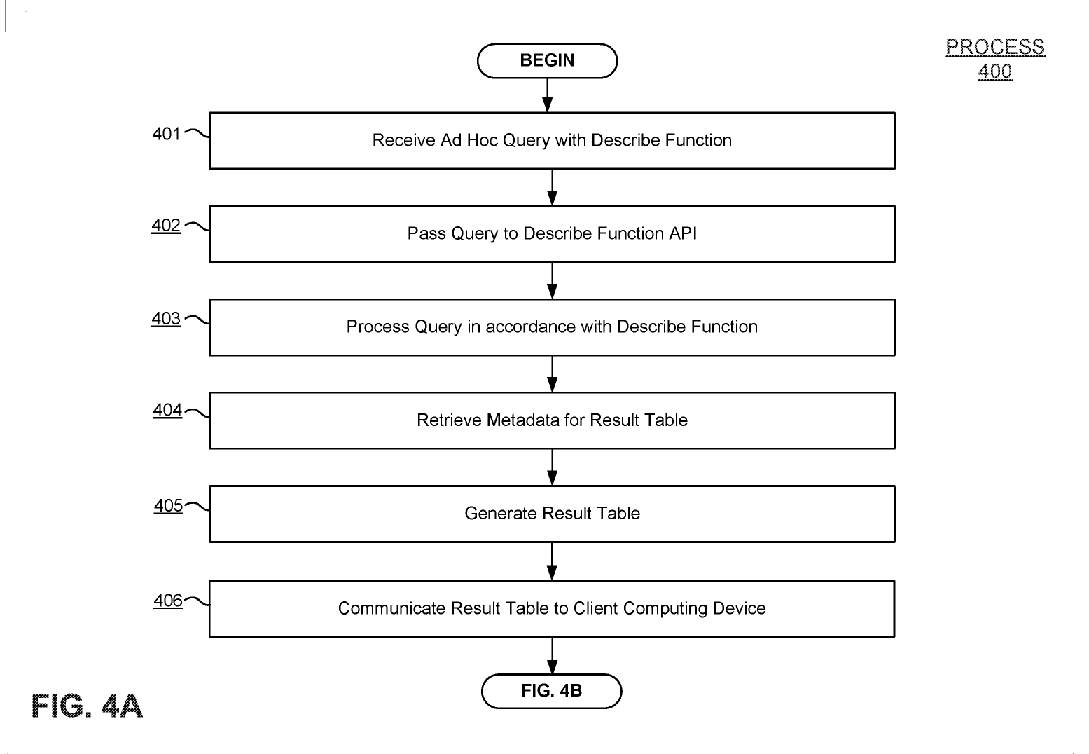

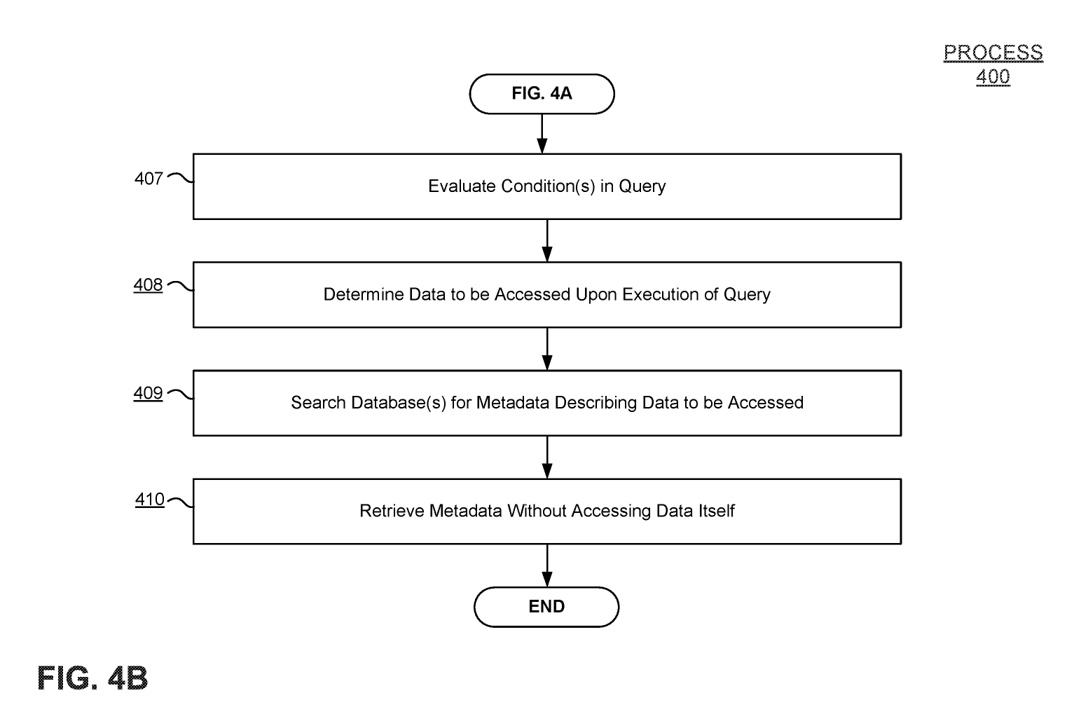

FIGS. 4A-4B depict flow charts of an example embodiment of a process for accessing metadata for ad hoc database queries in accordance with the techniques described in this disclosure. It is noted that the processes described below are exemplary in nature and are provided for illustrative purposes and not intended to limit the scope of the disclosure to any particular example embodiment. For instance, methods in accordance with some embodiments described in this disclosure may include or omit some or all of the operations described below, or may include steps in a different order than described in this disclosure. The particular methods described are not intended to be limited to any particular set of operations exclusive of all other potentially intermediate operations.

In addition, the operations may be embodied in computer-executable code, which causes a general-purpose or special-purpose computer to perform certain functional operations. In other instances, these operations may be performed by specific hardware components or hardwired circuitry, or by any combination of programmed computer components and custom hardware circuitry.

FIG. 4A depicts a flow chart of an example embodiment of a process for accessing metadata for ad hoc database queries in accordance with the techniques described in this disclosure. In the illustrated embodiment, process 400 begins at operation 401 by receiving an ad hoc database query with a describe function. The ad hoc query may be received from a client computing device via one or more communication networks. The database query may include a describe statement coded in a query language. The describe statement may be configured to access the describe function in accordance with the techniques described in this disclosure.

Process 400 continues by passing the database query to an API (or other equivalent interface or component) configured for implementing the describe function (operation 402). The describe function API can then process the database query in accordance with the describe function (operation 403). A result table including metadata describing the structure of the resulting data set can be retrieved from one or more databases (operation 404) and used to generate the result table (operation 405). The result table comprising the metadata describing the resulting data set may then be communicated to the client device (operation 406).

Process 400 continues in FIG. 4B, which includes further details regarding processing the query in accordance with the describe function. At operation 407, any conditions specified in the query may be evaluated. The results of evaluating the condition(s) in the query may then be analyzed to determine what data stored in one or more databases would be accessed if the database query were executed (operation 408). Once the data to be accessed by executing the query has been determined, process 400 continues by searching the one or more databases to identify metadata describing the structure of the data to be accessed by the query (operation 409), and retrieving the metadata from the one or more databases without accessing the data for the database query itself (operation 410). In one embodiment, the metadata may comprise the metadata 114 discussed above with respect to FIG. 1, which may describe the structure of the data for the database query and may include the metadata for one or more columns of the resulting data structure.

In one embodiment, execution of the database query may be prevented during processing of the describe statement. That is, the database query may not be executed to retrieve the resulting data set from the one or more databases. In one embodiment, the describe function may take the data structure of the resulting data set as an input operand and may generate the result table with one row per column for the data structure of the resulting data set.

In one embodiment, the describe function may use a query parser to analyze the database query and determine the structure of the computed data structure based on the metadata. The metadata for the data structure of the computed resulting data set may be retrieved in a manner analogous to prior art metadata describing static data structures stored in one or more database catalogs.

In one embodiment, the query may comprise an ad hoc query having at least one join condition. The resulting data structure may include a column name for the columns in the computed data structure, the data type for the columns in the computed data structure, and a description of the columns in the computed data structure. In one embodiment, the describe function may be implemented as a standard user-defined function.

This completes the description of process 400 in accordance with one example embodiment.

III. Illustrative Hardware Implementation

Embodiments of the present disclosure may be practiced using various computer systems including hand-held devices, microprocessor systems, programmable electronics, laptops, tablets and the like. The embodiments can also be practiced in distributed computing environments where tasks are performed by remote processing devices that are linked through one or more wire-based or wireless networks.

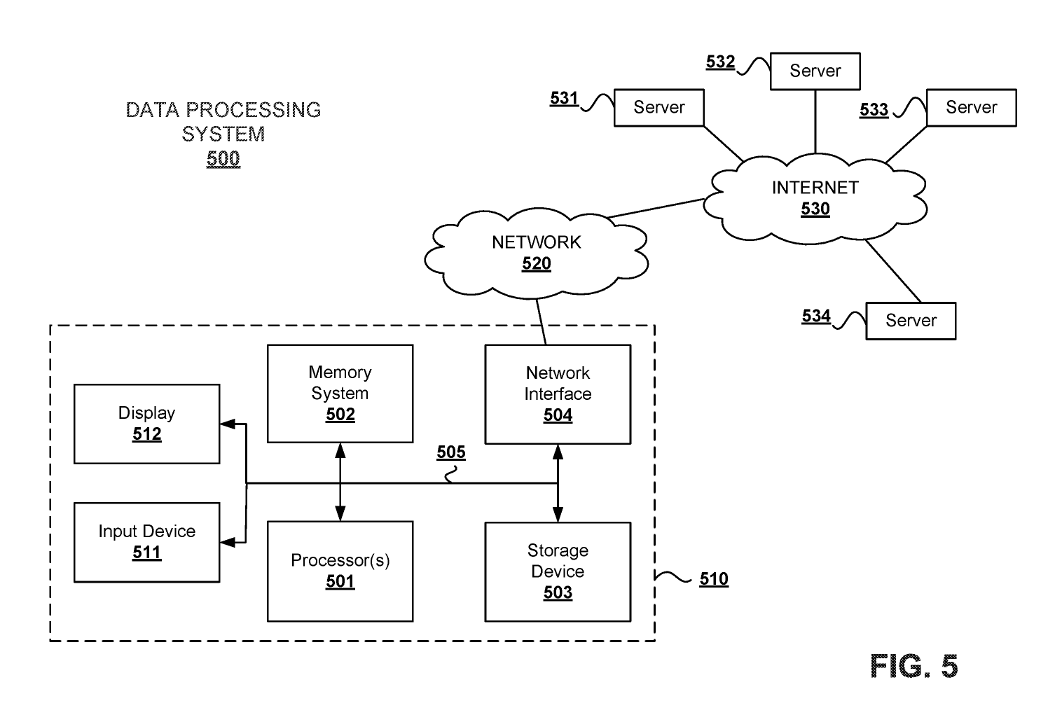

FIG. 5 depicts an example overview block diagram of a data processing system upon which the embodiments described in this disclosure may be implemented. The following hardware description is merely one example. It is to be understood that a variety of computers configurations may be used to implement the described techniques. While FIG. 5 illustrates various components of a data processing system 500, it is not intended to represent any particular architecture or manner of interconnecting components. It will also be appreciated that network computers and other data processing systems, which have fewer components or additional components, may be used. The data processing system 500 may, for example, comprise a personal computer (PC), workstation, laptop computer, tablet, smartphone or other hand-held wireless device, or any device having similar functionality.

In the illustrated embodiment, data processing system 500 includes a computer system 510. Computer system 510 includes an interconnect bus 505 (or other communication mechanism for communicating information) and one or more processor(s) 501 coupled with the interconnect bus 505 for processing information. Computer system 510 also includes a memory system 502 coupled with the one or more processors 501 via the interconnect bus 505. Memory system 502 is configured to store information and instructions to be executed by processor 501, including information and instructions for performing the techniques described above. This memory system may also be used for storing programs executed by processor(s) 501. Possible implementations of this memory system may be, but are not limited to, random access memory (RAM), read only memory (ROM), or combination thereof.

In the illustrated embodiment, a storage device 503 is also provided for storing information and instructions. Typically storage device 503 comprises nonvolatile memory. Common forms of storage devices include, for example, a hard drive, a magnetic disk, an optical disk, a CD-ROM, a DVD, a flash or other non-volatile memory, a USB memory card, or any other computer-readable medium from which a computer can read data and instructions. Storage device 503 may store source code, binary code, or software files for performing the techniques above. In addition, while FIG. 5 shows that storage device 503 as a local device connected with the components of the data processing system, it will be appreciated by skilled artisans that the described techniques may use a storage device remote from the system, such as a database or other network storage device coupled with the computer system 510 through a network interface such as network interface 504.

Network interface 504 may provide communications between computer system 510 and a network 520. The network interface 504 may be a wireless or wired connection, or any combination thereof. Computer system 510 is configured to send and receive information through the network interface 504 across one or more networks 520 such as a local area network (LAN), wide-area network (WAN), wireless or Bluetooth network, or the Internet 530, etc. Computer system 510 may access data and features on systems residing on one or multiple different hardware servers 531-534 across the network 520. Hardware servers 531-534 and associated server software may also reside in a cloud computing environment.

Storage device and memory system are both examples of non-transitory computer readable storage media. Embodiments in this disclosure can be embodied in computer-readable code stored on any computer-readable medium, which when executed by a computer or other data processing system, can be adapted to cause the system to perform operations according to the techniques described in this disclosure. Computer-readable media may include any mechanism that stores information in a form accessible by a data processing system such as a computer, network device, tablet, smartphone, or any device having similar functionality. Examples of computer-readable media include any type of non-transitory, tangible media capable of storing information thereon, including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing data and instructions in an electronic format. Computer-readable media can also be distributed over a network-coupled computer system stored and executed in a distributed fashion.

Further, computer system 510 may be coupled via interconnect bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized interconnect buses.

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a computer system. The techniques may be carried out in a computer system or other data processing system in response executing sequences of instructions stored in memory.

Throughout the foregoing description, for the purposes of explanation, numerous specific details were set forth in order to provide a thorough understanding of the disclosure. It will be apparent, however, to persons skilled in the art that these embodiments may be practiced without some of these specific details. The above examples and embodiments should not be deemed to be the only embodiments, and are presented to illustrate the flexibility and advantages of the present disclosure. Other arrangements, embodiments, implementations and equivalents will be evident to those skilled in the art and may be employed without departing from the spirit and scope of the disclosure as defined by the following claims.

What is claimed is:

1. A method comprising:
at a computer system in a network, the computer system comprising at least one processor and a memory in communication with the processor for storing computer code comprising instructions executable by the processor:
receiving a database query configured for implementing a describe function from a client computing device via the network, the database query comprising a describe statement coded in a query language configured to access the describe function;
passing the database query to an application programming interface (API) configured for implementing the describe function; and
processing the database query at the API in accordance with the describe function, wherein processing the describe function in accordance with the describe function comprises:
(1) analyzing the database query to determine what data stored in one or more databases in communication with the computer system would be accessed if the database query were executed;
(2) searching the one or more databases to identify metadata describing the structure of the data to be accessed by the database query; and
(3) retrieving the metadata from the one or more databases without accessing the data for the database query, wherein the metadata describes the structure of the data for the database query and includes metadata for one or more columns of the resulting data structure.

2. The method of claim 1 further comprising communicating a resulting data structure comprising the metadata to the client computing device.

3. The method of claim 2 wherein the describe function takes the computed data structure as an input operand and generates the resulting data structure with one row per column of the computed data structure.

4. The method of claim 1 further comprising preventing execution of the database query during processing of the describe statement, wherein the database query is not executed on the computed data structure to retrieve corresponding data from the one or more databases.

5. The method of claim 1 wherein the describe function uses a query parser in order to analyze the database query and determine the structure of the computed data structure based on the metadata.

6. The method of claim 1 wherein the metadata for the computed data structure is retrieved as if it were metadata for a static data structure stored in the database having the computed data structure.

7. The method of claim 1 further comprising running a compiler on the describe statement to analyze the database query.

8. The method of claim 1 wherein the query comprises an ad hoc query and includes at least one join condition.

9. The method of claim 1 wherein the resulting data structure comprises a column name for the columns in the computed data structure, the data type for the columns in the computed data structure, and a description of the columns in the computed data structure.

10. A system in communication with one or more databases via one or more communication networks, the system comprising:
at least one processor;
a memory configured to store programmed computer code executable by the processor to perform operations, the operations comprising:
receiving a database query configured for implementing a describe function from a client computing device via the network, the database query comprising a describe statement coded in a query language configured to access the describe function;
passing the database query to an application programming interface (API) configured for implementing the describe function; and
processing the database query at the API in accordance with the describe function, wherein processing the describe function in accordance with the describe function comprises:
(1) analyzing the database query to determine what data stored in one or more databases in communication with the computer system would be accessed if the database query were executed;
(2) searching the one or more databases to identify metadata describing the structure of the data to be accessed by the database query; and
(3) retrieving the metadata from the one or more databases without accessing the data for the database query, wherein the metadata describes the structure of the data for the database query and includes metadata for one or more columns of the resulting data structure.

11. The system of claim 10 wherein the operations further comprise communicating a resulting data structure comprising the metadata to the client computing device.

12. The system of claim 11 wherein the describe function takes the computed data structure as an input operand and generates the resulting data structure with one row per column of the computed data structure.

13. The system of claim 10 wherein the operations further comprise preventing execution of the database query during processing of the describe statement, wherein the database query is not executed on the computed data structure to retrieve corresponding data from the one or more databases.

14. The system of claim 10 wherein the metadata for the computed data structure is retrieved as if it were metadata for a static data structure stored in the database having the computed data structure.

15. The system of claim 1 wherein the query comprises an ad hoc query and includes at least one join condition.

16. A non-transitory computer readable storage medium storing programmed computer code executable by a computer system comprising at least one processor and a memory in communication with the processor, the operations comprising:
receiving a database query configured for implementing a describe function from a client computing device via the network, the database query comprising a describe statement coded in a query language configured to access the describe function;
passing the database query to an application programming interface (API) configured for implementing the describe function; and
processing the database query at the API in accordance with the describe function, wherein processing the describe function in accordance with the describe function comprises:
(1) analyzing the database query to determine what data stored in one or more databases in communication with the computer system would be accessed if the database query were executed;
(2) searching the one or more databases to identify metadata describing the structure of the data to be accessed by the database query; and
(3) retrieving the metadata from the one or more databases without accessing the data for the database query, wherein the metadata describes the structure of the data for the database query and includes metadata for one or more columns of the resulting data structure.

17. The computer readable storage medium of claim 16 wherein the describe function takes the computed data structure as an input operand and generates a resulting data structure with one row per column of the computed data structure.

18. The computer readable storage medium of claim 16 wherein the operations further comprise preventing execution of the database query during processing of the describe statement, wherein the database query is not executed on the computed data structure to retrieve corresponding data from the one or more databases.

19. The computer readable storage medium of claim 16 wherein the metadata for the computed data structure is retrieved as if it were metadata for a static data structure stored in the database having the computed data structure.

20. The computer readable storage medium of claim 16 wherein the query comprises an ad hoc query and includes at least one join condition.
